(19) United States
(12) Patent Application Publication
(10) Pub. No.: US 2002/0057067 A1
(43) Pub. Date: May 16, 2002

(54) Conductor configuration having a number of electrical conductors for carrying power to, and away from, a winding configuration

(76) Inventor: Jorn Steinbrink, Hannover (DE)

Correspondence Address: LERNER AND GREENBERG, P.A., Post Office Box 2480, Hollywood, FL, 33022-2480, US

(21) Appl. No.: 09/873,651

(22) Filed: Jun. 4, 2001

Related U.S. Application Data
(63) Continuation of application No. PCT/EP99/09270, filed on Nov. 29, 1999.

(30) Foreign Application Priority Data
Dec. 2, 1998 (EP) 98122902.4

(51) Int. Cl. H01B 11/02

(52) U.S. Cl. 318/135

(57) ABSTRACT

In order to reduce the electrical losses caused by current displacement in conductors in a conductor configuration having a number of electrical conductors for carrying power to, and away from, a winding configuration, which has a number of windings, in an electrical machine, in particular a generator, the respective conductors for carrying power to and away from a respective winding are adjacent to one another. The magnitude of the difference between the phase angles of current vectors of a conductor pair is thus as large as possible, and, in particular it is 180°.

### CROSS-REFERENCE TO RELATED APPLICATION:

This application is a continuation of copending International Application No. PCT/EP99/09270, filed Nov. 29, 1999, which designated the United States.

### BACKGROUND OF THE INVENTION

1. Field of the Invention

The invention relates to a conductor configuration having a number of electrical conductors, which is used for carrying power to, and away, from a winding configuration, which has a number of windings, in an electrical machine, in particular a rotating electrical machine.

Normally, a rotating electrical machine, for example a generator, has at least one electrical winding—also referred to as a winding section. During operation of the machine, the winding is supplied with an electric current. A configuration with electrical conductors for carrying power to the winding and/or for carrying power away from the winding is provided for this purpose. In general, losses caused by current displacement occur in the conductors.

An electrical machine that is in the form of a rotating electrical machine has a stator with a stator winding, and a rotor with a rotor winding. Depending on the configuration of the rotating electrical machine—as an electrical generator or as an electrical motor—a configuration is provided for carrying power to and/or away from the stator winding and/or the rotor winding. A large number of embodiments of rotating electrical machines and, in particular, their windings are described in a reference by Sequenz, Heinrich: titled “Die Wicklungen elektrischer Maschinen” [The Windings Of Electrical Machines], Volumes 1 to 4, 1954, Vienna, Springer-Verlag.

A winding pattern for electrical windings in a rotating electrical machine is described on page 158 of a reference by Giersch, Hans-Ulrich: titled “Elektrische Maschinen” [Electrical Machines], 1982, Stuttgart, Teubner-Verlag, which is configured for three-phase operation with three phases U, V and W. Each of the windings has a winding start and a winding end. The winding starts of the windings are accordingly annotated U1, V1 and W1, and their winding ends are annotated U2, V2, W2. The winding layout does not show how power is carried to the winding starts or away from the winding ends and whether a configuration with conductors is provided for this purpose.

U.S. Pat. Nos. 4,132,914 and 4,200,817 each describe specific winding configurations and proposes measures relating to how the voltage difference between two adjacent windings can be kept as small as possible in order, for example, to avoid flashovers between adjacent windings.

Connecting elements for winding ends of a winding configuration are known from U.S. Pat. Nos. 4,315,179 and 4,336,474. In order to keep the electromagnetic forces that act on the connecting elements low, a suitable phase angle is provided between the currents in adjacent connecting elements, and the connecting elements are at a distance from one another in the axial direction.

The cited documents generally relate to generator windings, but they do not deal with a conductor configuration for carrying power to, and away from, a winding configuration and, in particular, they do not deal with the problem of current displacement in the conductor configuration.

### SUMMARY OF THE INVENTION

It is accordingly an object of the invention to provide a conductor configuration having a number of electrical conductors for carrying power to, and away from, a winding configuration that overcomes the above-mentioned disadvantages of the prior art devices of this general type, in which conductors the current displacement is low.

With the foregoing and other objects in view there is provided, in accordance with the invention, a conductor configuration containing a plurality of electrical conductors for carrying power to, and away from a winding configuration having a plurality of windings of an electrical machine. The electrical conductors have a first conductor for carrying the power to a respective winding of the windings and a second conductor for carrying the power away from the respective winding. The first conductor and the second conductor are disposed adjacent to one another and form a conductor pair such that a magnitude of a difference between phase angles of current vectors of the conductor pair is as large as possible.

In the following text, the term conductor pair always refers to the combination of two conductors for carrying power to and away from at least one winding in each case.

The conductors in the conductor pair are thus disposed such that the power is carried to and away from a winding in mutually adjacent conductors during operation of the generator. The currents flowing in the conductors have a phase shift of 180° between them. In consequence, the influence, resulting from the conductor pair, on the current density distributions in the other conductors is reduced by the magnetic fields caused by the conductor pair, thus reducing current displacement in the other conductors. The losses in the conductors arising from current displacement are thus also low and the risk of severe heating of the conductors and of damage, which is possible as a result of the heating, to the insulation surrounding the conductors, is in consequence reduced. Relatively little heating therefore occurs in the conductor configuration. This is a major advantage, particularly when the components are cooled indirectly. Although the reduction in the power losses due to the described measure is negligible in comparison to the overall power losses, the reduction nevertheless results in a considerable decrease in the component temperature in the region of the conductor configuration from, for example, 120° C. to 180° C., and thus allows operation in a permissible temperature range without having to carry out further cooling measures.

The amount of current displacement that occurs is dependent, in particular, on the respective current vectors of the respective conductor currents that are formed in the conductors. The term current vector in this context relates to the transformed variable, associated with a sinusoidal conductor current, in the complex domain for complex calculation. The current displacement is also influenced by the respective conductor cross sections, the respective conductor circumferences, and the distances between the conductors.

The conductors are in this case preferably disposed such that virtually any resultant current vector, which is formed by the addition of the current vectors of the conductor currents in two directly adjacent conductors, has as low a magnitude as possible. The magnitude of the resultant current vector from adjacent conductors is low when the difference between the phase angles of the current vectors of the conductor currents in the conductors is as large as possible. The configuration according to the invention makes use of the fact that the mutual influence between the conductor currents in two adjacent conductors becomes less the smaller the resultant current vector of the current vectors of the conductor currents is. The magnetic fields caused by the conductor currents in this case largely cancel one another out. If, for example, the configuration has six conductors, then the conductors can be disposed such that the respective resultant current vector for three mutually adjacent conductors has as small a magnitude as possible.

In one preferred embodiment, the configuration has a number of conductor pairs, in particular three, which are each used for carrying power to and away from at least one of the windings, with the conductors for carrying power to the windings or the conductors for carrying power away from the windings in adjacent conductor pairs being adjacent to one another.

In a configuration having three conductor pairs, as is normally the case for polyphase operation with three phases, this measure ensures that the phase angle between the current vectors in adjacent conductors is as large as possible. To be precise, the phase differences between the conductors in one conductor pair are—as already mentioned—180°, and the phase differences between the adjacent conductors in mutually adjacent conductor pairs are 120°.

In one advantageous alternative to this, that conductor in a conductor pair that carries power to the windings is disposed alongside that conductor in the adjacent conductor pair which carries power away from the windings. The phase angle between the adjacent conductor pairs is in this case only 60° which in comparison to the abovementioned alternative—has a disadvantageous effect on the current displacement. However, this disadvantage is compensated for by the advantage of simpler structural configuration and, in particular, the connection of the conductors to the winding configuration is in this case comparatively simple.

In this configuration of six conductors, the phase angles at any given time—in each case with respect to a reference phase angle of 0°—between the current vectors of the conductor currents in the conductors in the first conductor pair are 90° and −90°, the phase angles in the conductors in the second conductor pair are 150° and −30°, and the phase angles in the conductors in the third conductor pair are −150° and 30°. The second conductor pair is preferably disposed between the two other conductor pairs, with the conductor whose phase angle is +150° being adjacent to the conductor whose phase angle is −90° in the first conductor pair, and with the conductor whose phase angle is −30° being adjacent to the conductor whose phase angle is −150° in the third conductor pair.

In a further preferred refinement, the configuration is directed along a major axis and has conductor planes that are at a distance from one another along the major axis. During manufacture, it is easy to dispose the conductors in the conductor planes; in this case, a number of conductors can also be disposed in one conductor plane. In a configuration such as this, the conductors can easily be replaced, and the distances between the conductor planes, and hence the distances between the conductors, can easily be varied and can be adjusted individually in order to achieve low current displacement.

The configuration preferably has six conductor planes, with one of the conductors being disposed in each conductor plane. In consequence, the configuration is configured primarily for operation with three-phase current, and the mutual influence between the conductor currents carried in the conductors is reduced, since only one conductor is disposed in each conductor plane.

With six conductors and taking account of the described mutual configuration, it follows that the first conductor pair is disposed in first and second conductor planes, the second conductor pair is disposed in third and fourth conductor planes, and the third conductor pair is disposed in fifth and sixth conductor planes. In this case, it is once again preferable to ensure that mutually adjacent conductors in adjacent conductor pairs are each used for carrying power to or away from the windings, so that there is a phase difference of 120° between their conductor currents.

According to the invention, there are further options for allocating the conductors to the conductor planes in a configuration having an even number of conductors and the same number of conductor planes, as follows.

The conductors are split into pairs such that the two conductors in each pair carry those conductor currents whose magnetic fields virtually completely cancel one another out. Therefore, the resultant magnetic field of the conductor currents from such a pair has a very low magnetic field strength, of virtually zero. This is the situation with the defined conductor pairs. The conductor planes in the configuration are combined to form pairs of planes, with each pair of planes containing two conductor planes disposed directly alongside one another. The further options mentioned above result from one, and only one, pair being disposed in each pair of planes, although each pair can be positioned as required. In this case, one and only one conductor of the pair is disposed in each conductor plane in a pair of planes; however, the conductors in the pair can be positioned as required. If there are six conductors, these are thus combined to form pairs, in particular to form three conductor pairs.

In addition, the configuration preferably has five conductor planes, with a number of conductors, in particular two, being disposed in one of the conductor planes. This reduces the number of conductor planes, hence reducing the physical extent of the configuration.

Two conductors of two conductor pairs are in this case preferably disposed jointly in one conductor plane. It is particularly expedient for the two conductors respectively to be used for carrying power to or away from one of the windings since, in this case, this results in as large a phase difference as possible between the adjacent conductors. This refinement thus offers the advantage that any current displacement that occurs in the conductors is particularly low.

According to a further preferred refinement, the adjacent conductors overlap over as great a length as possible along one section. In consequence, the magnetic fields from the conductor currents in the adjacent conductors largely cancel one another out over as great a length as possible.

According to a further preferred refinement, the adjacent conductor planes are each at a distance of between 70 mm and 100 mm, in particular of 80 mm, from one another. Spacing the conductor planes ap art from one another at such a distance is based on the consideration, particularly in the case of a configuration for a large electrical machine, first of choosing the distances to be as large as possible, so that the mutual influence between the currents in the conductor planes is low while, at the same time, still choosing the distances to be sufficiently small that the configuration can be handled. The distances within the stated range and taking account of the boundary configuration conditions, are particularly advantageous with regard to the mutual influence between the currents in the conductors in the conductor planes, while the configuration can at the same time be handled easily.

Those conductors that are connected to the winding ends, that is to say the conductors for carrying power away from the winding ends, are short-circuited to one another. In consequence, the windings can easily be star-connected.

According to a further preferred refinement, the ratio of the conductor circumference to the conductor cross-sectional area is between π mm⁻¹ and 30 mm⁻¹. Choosing a ratio such as this results in that the available conductor cross-sectional area has a particularly uniform current density distribution for current displacement in all directions. To this end, it is advantageous to choose the surface area, and hence the conductor circumference, to be as large as possible. Design considerations are, of course, taken into account in the process, since the conductor circumference cannot be selected to be infinitely large.

Other features which are considered as characteristic for the invention are set forth in the appended claims.

Although the invention is illustrated and described herein as embodied in a conductor configuration having a number of electrical conductors for carrying power to, and away from, a winding configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a circuit diagram of a configuration according to the invention;

FIG. 2 is a perspective view of a refinement of the configuration;

FIG. 3 is a plan view of the configuration shown in FIG. 2;

FIG. 4 is a circuit diagram for a further configuration; and

FIG. 5 is a plan view of the further configuration shown in FIG. 4.

### DESCRIPTION OF THE PREFERRED EMBODIMENTS

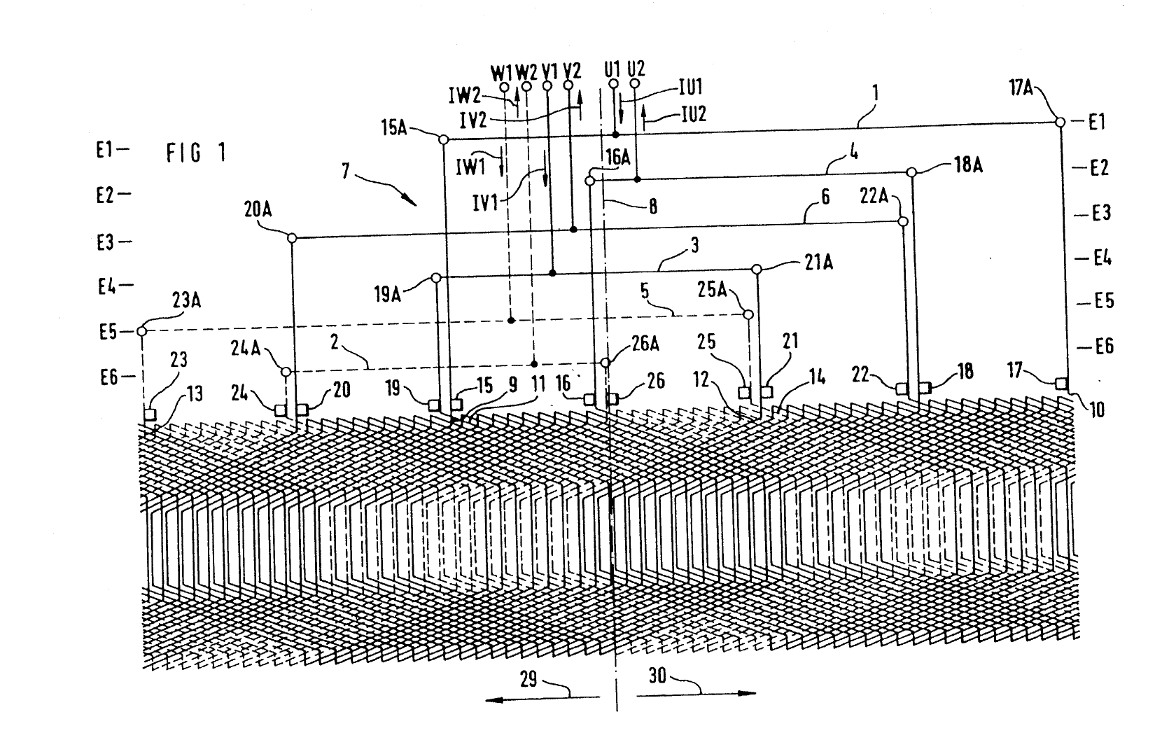

In all the figures of the drawing, sub-features and integral parts that correspond to one another bear the same reference symbol in each case. Referring now to the figures of the drawing in detail and first, particularly, to FIG. 1 thereof, there is shown a circuit diagram of a configuration 7 having six conductors 1 to 6, which have respective connections U1, W2, V1, U2, W1 and V2. The configuration 7 is aligned along a major axis 8 and has six conductor planes E1, E2, E3, E4, E5 and E6, with the conductor 1 being disposed in the conductor plane E1, the conductor 4 in the conductor plane E2, the conductor 6 in the conductor plane E3, the conductor 3 in the conductor plane E4, the conductor 5 in the conductor plane E5, and the conductor 2 in the conductor plane E6.

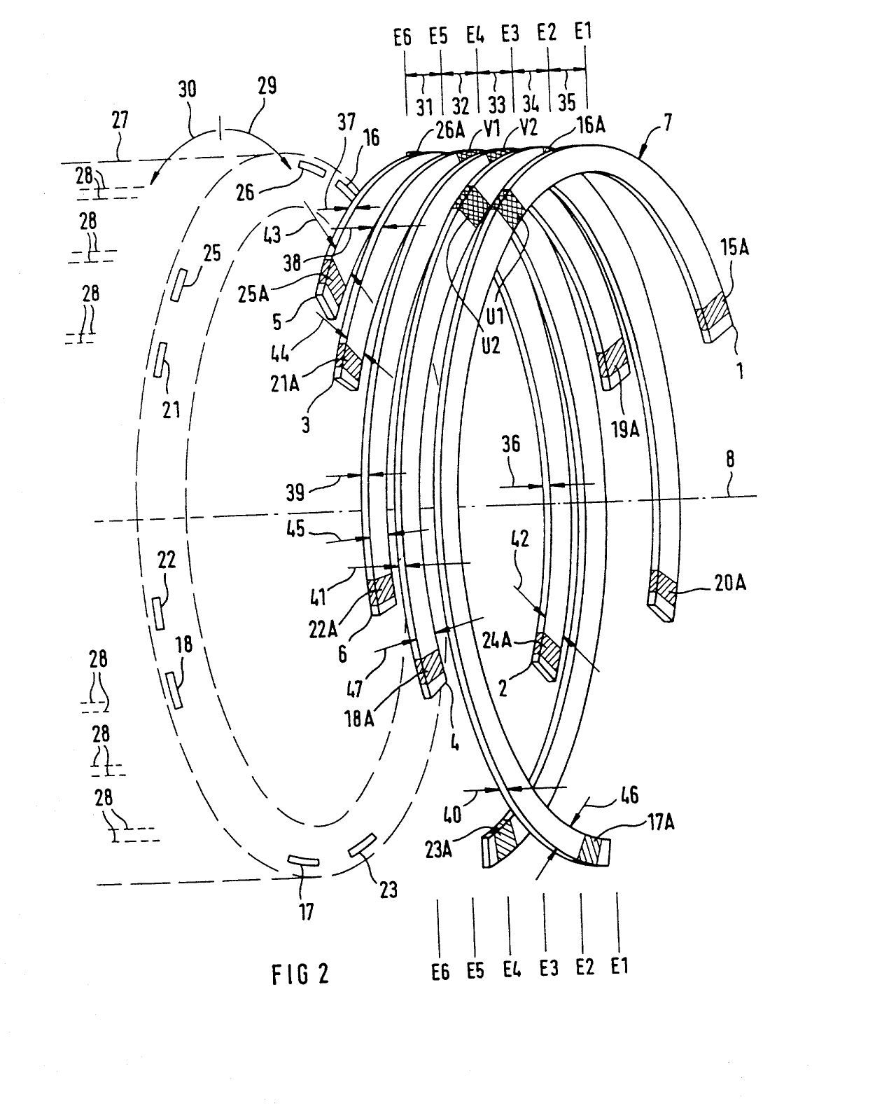

The circuit diagram shows a winding configuration directed along the major axis 8 and being wound with six windings 9 to 14, which are disposed along the circumference of a stator 27 as shown in FIG. 2. Directions 29 and 30 each point in the circumferential direction, and indicate the winding direction. The winding 9 has a winding start 15 and a winding end 16, the winding 10 has a winding start 17 and a winding end 18, the winding 11 has a winding start 19 and a winding end 20, the winding 12 has a winding start 21 and a winding end 22, the winding 13 has a winding start 23 and a winding end 24, and the winding 14 has a winding start 25 and a winding end 26. Each winding start and each winding end is connected to one of the conductors 1 to 6. These refinements result in that the windings 9 to 14 can be connected as required, for example star-connected or delta-connected, outside the stator 27 and/or outside a rotor via the conductors 1 to 6.

The windings 9 and 10 are connected in parallel, with their winding starts 15 and 17 being electrically connected to one another via the conductor 1, and their winding ends 16 and 18 being electrically connected to one another via the conductor 4. The windings 11 and 12 are likewise connected in parallel, with their winding starts 19 and 21 being connected to one another via the conductor 3, and their winding ends 20 and 22 being connected to one another via the conductor 6. In the same way, the windings 13 and 14 are connected in parallel, with their winding starts 23 and 25 being connected to one another via the conductor 5, and their winding ends 24 and 26 being connected to one another via the conductor 2. A conductor current IU1 can thus be supplied via the connection U1 and the conductor 1 to the windings 9 and 10, and a conductor current IU2 can be carried away from these via the conductor 4 and the connection U2. Furthermore, a conductor current IV1 can be supplied to the windings 11 and 12 via the connection V1 and the conductor 3, and can be carried away from these, as a conductor current IV2, via the conductor 6 and the connection V2. A conductor current IW1 can likewise be supplied to the windings 13 and 14 via the connection W1 and the conductor 5, and can be carried away from the windings 13 and 14, as a conductor current IW2, via the conductor 2 and the connection W2.

The connections U1, V1 and W1 are thus used for carrying power to the winding starts 15, 17; 19, 21 and 23, 25, and the connections U2, V2 and W2 are used for carrying power away from the winding ends 16, 18; 20, 22 and 24, 26. The conductors (for example 1) for carrying power to a winding (for example 9 and 10) are each adjacent to the conductor (i.e. 4) for carrying power away from the winding (i.e, 9, 10,) so that the phase difference between the currents flowing through these two conductors 1, 4 is maximum, and is 1800. The current-displacement influence on the other conductors 2, 3, 5, 6 is thus kept as low as possible. The two conductors 1, 4 form a conductor pair.

The windings 9 to 14 and the configuration 7 are configured for three-phase operation within an operating frequency band Δf for example from 40 Hz to 70 Hz. The current vectors IU1, IU2, IV1, IV2, IW1 and IW2 of the conductor currents IU1, IU2, IV1, IV2, IW1 and IW2 each have an associated phase angle φU1, φU2, φV1, φV2, φW1 and φW2 which, with respect to 0° as a phase angle, are, at a time t₀, φU1=90°, φU2=−90°, φV1=−30°, φV2=150°, φW1=−150° and φW2=30°. Thus, in the exemplary embodiment, three mutually adjacent conductor pairs 1,4; 6,3; 5,2 are provided for respectively carrying power to and away from two windings 9,10; 11,12; 13,14 in each case.

Since the conductors 1 to 6 are disposed, as described, in the planes E1 to E6, the magnitudes of the differences between the phase angles of the resultant vectors of the conductor currents in directly adjacent conductors are as large as possible. The phase difference is in each case 180° between the conductors (for example 1, 4) in a conductor pair and, in the configuration shown in FIG. 1, the phase difference between the mutually adjacent conductor pairs 1,4; 6,3; 5,2 is 120°. In this case, the conductors (for example 4, 6) for carrying power away from the windings in two adjacent conductor pairs (1,4 and 3,6) are adjacent to one another. The conductor 4 for carrying power away from the windings in the first conductor pair 1,4 is thus adjacent to the conductor 6 for carrying power away from the windings in the second conductor pair 3,6. With a three-phase configuration, this therefore results in as large a phase difference as possible between all adjacent conductors (1 to 6). A phase difference which is as large as possible is thus equivalent to the magnitude of the resultant vectors of adjacent conductors 1,4; 4,6; 6,3; 3,5; 5,2 being as small as possible. As already mentioned, the magnitude of the difference between the phase angles of the current vectors (for example IU1 and IU2) of the conductors 1,4 in a conductor pair is 180°. The magnitude of the resultant current vector of the conductor pair 1,4 formed by adding the current vectors IU1 and IU2 of the conductor currents IU1 and IU2 is thus equal to zero. The same is true, in an analogous manner, for the two other conductor pairs 3,6 and 5,2.

The current displacement in the conductors 1 to 6 is effectively reduced by their configuration according to the invention, and the electrical losses in the conductors 1 to 6 are thus reduced. The reduction in the current displacement in the conductors 1 to 6 can also be achieved by disposing the conductor 6 in the conductor plane E4, and the conductor 3 in the conductor plane E3. Therefore, in adjacent conductor pairs (for example 1,4 and 3,6), the conductor 4 for carrying power away from the windings in the one conductor pair 1,4 is adjacent to the conductor 3 for carrying power to the windings in the other conductor pair 3,6. Thus, in a three-phase configuration, this results in a phase difference of 60° between the conductor pairs 1,4 and 3,6, that is to say between the conductors 4 and 3.

FIG. 2 provides a three-dimensional illustration of one embodiment of the configuration 7. As shown in FIG. 1, the windings 9 to 14 are in this case disposed along the circumference of the stator 27 of a rotating electrical machine, which is not illustrated in any more detail. The directions 29 and 30 in this case point in the circumferential direction, according to FIG. 1. To make the illustration clearer, the winding starts 17, 21, 23 and 25, and the winding ends 16, 18, 22 and 26, on the stator 27 are only indicated. The winding starts 15 and 19, and the winding ends 20 and 24, cannot be seen. The conductors 1 to 6 are each located, as shown in FIG. 1, in one of the conductor planes El to E6. The conductors 1 to 6 each have a rectangular profile with respective widths 40, 36, 38, 41, 37 and 39 and respective heights 46, 42, 44, 47, 43 and 45. For clarity reasons, only those contact points 15A to 26A on the conductors 1 to 6 are shown, at which the conductors 1 to 6 (as shown in FIG. 1) are connected to the winding starts 15, 17, 19, 21, 23 and 25, and to the winding ends 16, 18, 20, 22, 24 and 26.

Adjacent conductor planes (E1,E2); (E2,E3); (E3,E4); (E4,E5); (E5,E6); are each separated from one another by respective distances 31 to 35 of 80 mm. The mutual influence from conductor currents that are carried by adjacent conductors is thus low. Depending on the configuration of the dimensions of the rotating electrical machine, the distances 31 to 35 can be chosen such that the losses that occur due to current displacement are low.

The respective conductor cross-sectional area, which is a result of the respective height 46, 42, 44, 47, 43 or 45 and width 40, 36, 38, 41, 37 or 39 of each conductor, can likewise be chosen such that the respective ratio of the conductor circumference to the conductor cross-sectional area which the conductor circumference surrounds is as large as possible. The height 46, 42, 44, 47, 43 or 45 and the width 40, 36, 38, 41, 37 or 39 of the conductor 1 to 6 must, of course, be chosen to take account of the dimensions of the rotating electrical machine. In particular, the height 46, 42, 44, 47, 43 or 45 of the conductors 1 to 6 in the direction of the major axis 8 is limited, for example, by a rotating machine shaft, which is not illustrated but extends along the major axis 8, or by other winding components, which are not illustrated in any more detail. In this case, the ratio of the conductor circumference to the conductor cross-sectional area is chosen to be between π mm⁻¹ and 30 mm⁻¹.

The configuration of the conductors 1 to 6 in the conductor planes E1 to E6 offers physically simple conductor routing and, in addition, the conductors 1 to 6 can easily be replaced. For reasons of clarity, FIG. 2 does not show a device used to support the conductors 1 to 6.

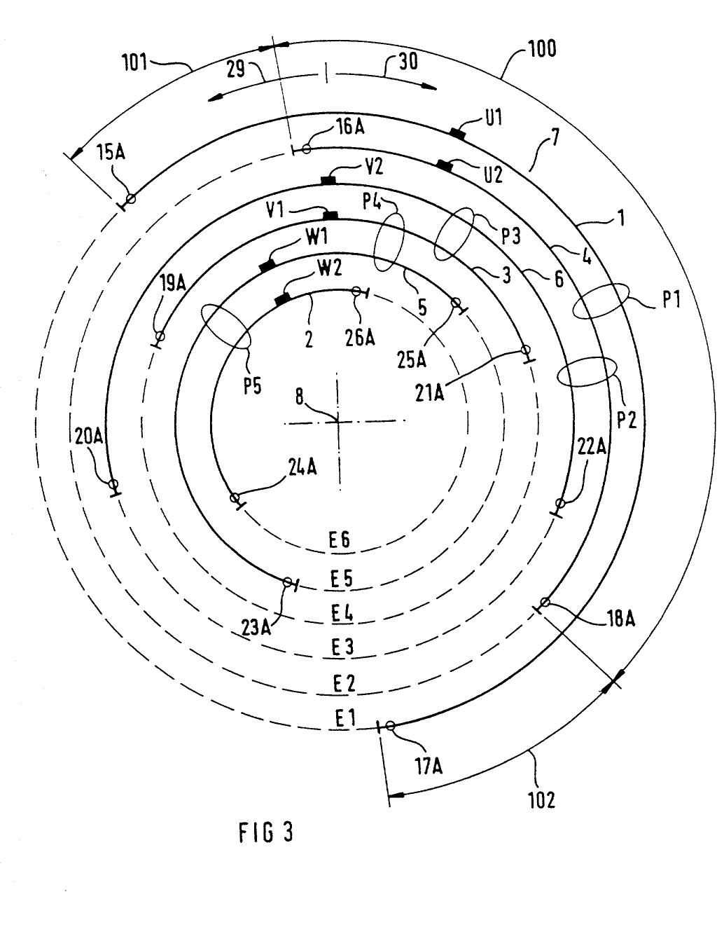

FIG. 3 shows a highly schematic plan view of the configuration 7 along the major axis 8 in a direction of the plane 1. FIG. 3 shows how the conductors 1 to 6 each extend along a respective circle circumference. To make the illustration clearer, the planes E1 to E6 are shown in one another and not one behind the other. Adjacent conductors in each case form a pair, to be precise with the conductors 1 and 4 forming the pair P1, the conductors 4 and 6 forming the pair P2, the conductors 6 and 3 forming the pair P3, the conductors 3 and 5 forming the pair P4, and the conductors 5 and 2 forming the pair P5.

The conductors 1 to 6 in each of the pairs P1, P2, P3, P4, P5 are configured such that the respective circumferential region over which the conductors associated with a pair jointly extend is as large as possible. In other words, the conductors (for example 1, 4) in a pair P1 overlap over as great a length as possible along the circumference of a section. The magnetic fields from the conductor currents in each pair thus largely cancel one another out along the respective circumferential region, or along the respective common section of the conductors 1, 4 in the pair P1. For example, the conductors 1 and 4 in the pair P1 extend jointly along a circumferential region 100. Although circumferential regions 101 and 102 are covered only by one conductor in the pair P1, namely the conductor 1, and the magnetic field of the conductor current flowing in the conductor 1 can act on the currents in the conductors 6, 3, 5 and 2, this effect is generally low, however, since the circumferential regions 101 and 102 according to the invention are very small. Ideally, the conductors 1 to 6 would be configured such that they all cover the same circumferential region. This would reduce the mutual influence between the magnetic fields of the conductor currents to as great an extent as possible. Such a configuration of the conductors is generally difficult, if not impossible, for configuration reasons.

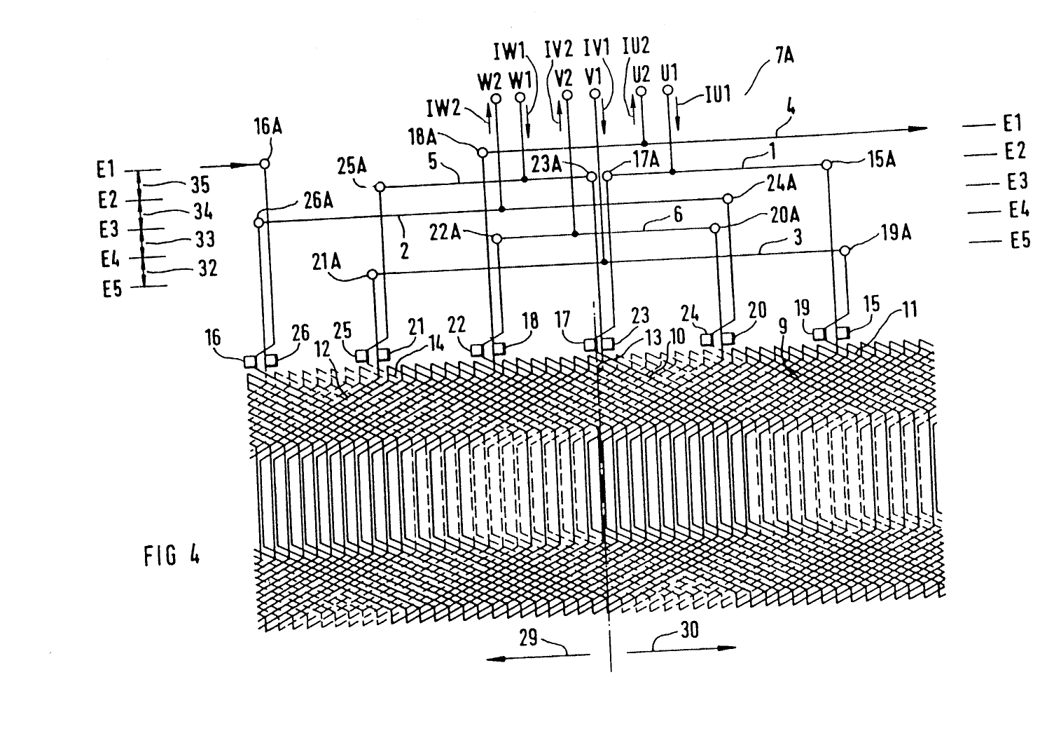

FIG. 4 shows a circuit diagram for a configuration 7A with five conductor planes E1 to E5. The configuration 7A is connected to the windings 9 to 14 and to the winding starts 15, 17, 19, 21, 23 and 25 and the winding ends 16, 18, 20, 22, 24 and 26. In contrast to FIG. 1, the configuration 7A has only five conductor planes E1 to E5. Thus, in the configuration 7A, the distances 32 to 35 between the conductor planes E1 to E5 can be chosen to be larger than in the configuration 7 shown in FIGS. 1 to 3, if both configurations 7 and 7A are of the same size in the major axis direction. This advantageously reduces the mutual influence between the conductors 1 to 6 disposed in the conductor planes E1 to E5.

Taking account of the phase angles (analogously to the situation described with respect to FIG. 1) of the current vectors (IU1, IU2, IV1, IV2, IW1 and IW2 of the conductor currents IU1, IU2, IV1, IV2, IW1 and IW2 carried in the conductors 1 to 6, the conductors 1 to 6 are disposed such that little mutual influence, and hence little current displacement, occurs in the conductors 1 to 6. In this case, the conductor 4 is disposed in the conductor plane E1, the conductor 1 and the conductor 5 are disposed in the conductor plane E2, the conductor 2 is disposed in the conductor plane E3, the conductor 6 is disposed in the conductor plane E4, and the conductor 3 is disposed in the fifth conductor plane ES.

A configuration such as this ensures that the conductors (for example 4,1 and 5,2) in the individual conductor pairs 4,1; 5,2 for carrying power to and away from a respective winding (for example 9,10 or 13,14, respectively) are directly adjacent. Conductors 1,5 of two adjacent conductor pairs 1,4; 5,2 are accordingly disposed in the conductor plane E2 which is occupied by two conductors. In FIG. 4, the two conductors 5,1 which are disposed in the conductor plane E2 are each used for carrying power to the windings via the respective connections W1 and U1. This leads to a phase difference of 60° between the conductors 4 and 5 and between the conductors 1 and 2. If the conductor 2, rather than the conductor 5, is disposed together with the conductor 1 in the conductor plane E2, then the phase difference between the conductors 4,2 and 1,5, which are then adjacent, is in each case 120°, which is better with regard to the problem of current displacement. In this case, the conductors 6 and 3 are likewise interchanged with respect to their configuration in the conductor planes E4 and ES, in order to achieve a phase difference of 120° between the conductors 3 and 5 which are then adjacent.

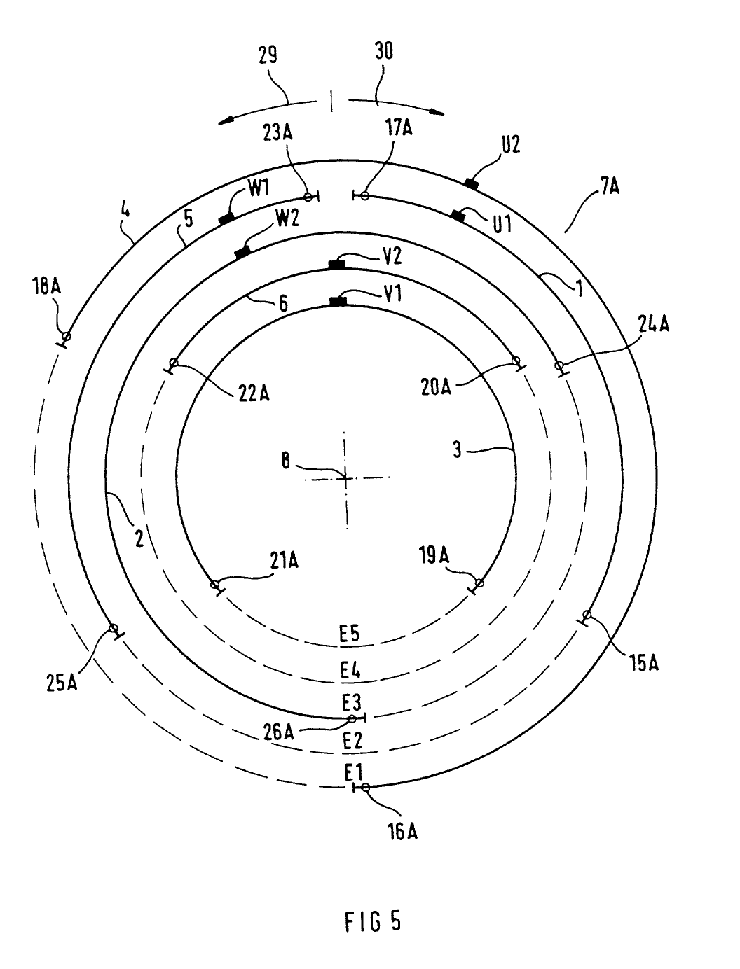

Analogously to FIG. 3, FIG. 5 shows a plan view of the configuration 7A along the major axis 8 from the conductor plane E6 in the direction of the plane E1. FIG. 5 shows how each conductor 1 to 6 extends along a respective circle circumference. A three-dimensional configuration of the configuration 7A could be configured analogously to the configuration of the configuration 7 shown in FIG. 2 but, in this case, the conductor plane E6 would be missing, and the two conductors 1 and 5 would be disposed in the conductor plane E2.

I claim:

1. A conductor configuration, comprising:
a plurality of electrical conductors for carrying power to, and away from a winding configuration having a plurality of windings of an electrical machine, said electrical conductors having a first conductor for carrying the power to a respective winding of the windings and a second conductor for carrying the power away from the respective winding, said first conductor and said second conductor disposed adjacent to one another and forming a conductor pair such that a magnitude of a difference between phase angles of current vectors of said conductor pair is as large as possible.

2. The configuration according to claim 1, wherein said electrical conductors are disposed such that the magnitude of the difference between the phase angles of the current vectors of said electrical conductors disposed adjacent to each other is as large as possible.

3. The configuration according to claim 1, wherein said electrical conductors form a plurality of conductor pairs each carrying th e power to and away from at least one of said windings, said conductor pairs being disposed adjacent to each other such that a respective conductor for carrying the power to the windings of a first conductor pair of said conductor pairs is disposed adjacent to a respective conductor for carrying the power to the windings of a second conductor pair of said conductor pairs.

4. The configuration according to claim 1, wherein said electrical conductors form a plurality of conductor pairs each carrying the power to and away from at least one of the windings, said conductor pairs being disposed adjacent to each other such that a respective conductor for carrying the power to the windings of a first conductor pair of said conductor pairs is disposed adjacent to a respective conductor for carrying the power away from the windings of a second conductor pair of said conductor pairs.

5. The configuration according to claim 1, wherein the electrical machine has a major axis and said electrical conductors are disposed along the major axis, said electrical conductors are disposed in a plurality of conductor planes which are at a distance from one another along the major axis.

6. The configuration according to claim 5, wherein said plurality of conductor planes is six conductor planes and one of said electrical conductors is disposed in each of said conductor planes.

7. The configuration according to claim 5, wherein said plurality of conductor planes is five conductor planes and two of said electrical conductors is disposed in one of said conductor planes.

8. The configuration according to claim 5, wherein said electrical conductors form a plurality of conductor pairs each carrying the power to and away from at least one of the windings and each of said conductor pairs is formed of two of said electrical conductors.

9. The configuration according to claim 8, wherein two of said electrical conductors in two of said conductor pairs are disposed jointly in one of said conductor planes.

10. The configuration according to claim 9, wherein said two conductors disposed jointly in said one of said conductor planes are used for carrying the power to the windings.

11. The configuration according to claim 8, wherein adjacent one of said electrical conductors overlap over as great a length as possible along one section.

12. The configuration according to claim 5, wherein said conductor planes which are directly adjacent conductor planes each being at the distance of between 70 mm and 100 mm from one another.

13. The configuration according to claim 8, wherein said electrical conductors for carrying the power away from the windings are short-circuited to one another.

14. The configuration according to claim 1, wherein said electrical conductors have a conductor circumference and a conductor cross-section area such that a ratio of said conductor circumference to said conductor cross-sectional area is between π mm⁻¹ and 30 mm⁻¹ for each of said electrical conductors.

15. The configuration according to claim 1, wherein the magnitude of the difference between the phase angles of the current vectors of said conductor pair is 180°.

16. The conductor configuration according to claim 1, wherein the electrical machine is a generator.

17. The configuration according to claim 1, wherein said electrical conductors form a plurality of conductor pairs each for carrying the power to and away from at least one of the windings, said conductor pairs being disposed adjacent to each other such that a respective conductor for carrying power away from the windings of a first conductor pair of said conductor pairs is disposed adjacent to a respective conductor for carrying the power away from the windings of a second conductor pair of said conductor pairs.

18. The configuration according to claim 9, wherein said two conductors disposed jointly in said one of said conductor planes are used for carrying the power away from the windings.

19. The configuration according to claim 5, wherein said conductor planes which are directly adjacent conductor planes each are at the distance of 80 mm from one another.
